(19) United States
(12) Patent Application Publication
(10) Pub. No.: US 2006/0078098 A1
(43) Pub. Date: Apr. 13, 2006

(54) Answering phone calls

(76) Inventor: Marcel J. Sereboff, Westlake Village, CA (US)

Correspondence Address: SoCAL IP LAW GROUP LLP, 310 N. WESTLAKE BLVD. STE 120, WESTLAKE VILLAGE, CA, 91362, US

(21) Appl. No.: 10/961,956

(22) Filed: Oct. 8, 2004

(51) Int. Cl. H04M 11/00; H04M 1/66; H04M 3/16

(52) U.S. Cl. 379/93.02; 379/93.03; 455/411

(57) ABSTRACT

A telephone and methods of operating a telephone are disclosed. The telephone may have a casing, a microphone, a speaker and a memory. The telephone may receive calls through at least one of a wireless or wire line telephone network. The telephone may store a voice print of a user in the memory. The telephone may receive a signal of an incoming call, and in response generate a call alert. The telephone may monitor for a voice signal which matches the voice print. Upon determination of a match, the telephone may go directly going off hook and enable use of the microphone and the speaker without further steps by the user or the telephone.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention relates to apparatus and methods for answering phone calls.

2. Description of the Related Art

A drawback with typical telephones is the relatively short window of time before an incoming call is timed out. That is, the incoming call is terminated if the call is not answered within the pre-set time period. This can be very frustrating for a user who intends to take an incoming call, but finds that he is unable to do so only because the telephone may be in a slightly inaccessible place. For example, the user may have placed the telephone in a purse or in an unknown location, but within earshot. In these cases, the call will often be terminated before the user has had sufficient opportunity to take the call, although the intention was to answer it.

### DESCRIPTION OF THE DRAWINGS

FIG. 1 is a perspective view of a portable telephone.

FIG. 2 is a block diagram of a telephone.

FIG. 3 is a flowchart of a method of answering phone calls.

### DETAILED DESCRIPTION OF THE INVENTION

Throughout this description, the embodiments and examples shown should be considered as exemplars, rather than limitations on the apparatus and methods of the present invention.

Description of Systems

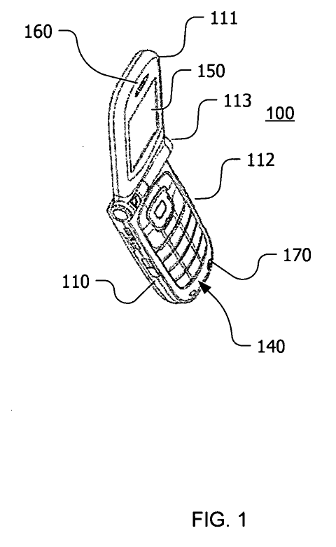

Referring now to FIG. 1 there is a perspective view of a portable telephone 100. The portable telephone 100 may be wireless (e.g., cellular) or cordless (i.e., communicative with a local base station connected to a land line). The telephone 100 includes a casing 110, and disposed within or on (collectively referred to herein as “within”) the casing are a keypad 140, a display 150, a speaker 160 and a microphone 170. The user-interface of the telephone 100 comprises the keypad 140, the display 150, the microphone 160 and the speaker 170.

The casing 110 includes an upper section 111 and a lower section 112, connected by a hinge 113. The telephone 100 has a clamshell or flip-phone design. Thus, the telephone 100 has a closed position where the upper section 111 and the lower section 112 are touching, and an open position where they are not. The telephone 100 includes a flip sensor to sense whether the telephone 100 is in the open position or the closed position.

The keypad 140 has alpha numeric keys associated with alphanumeric data for use in dialing telephone numbers and entering alphanumeric data into the telephone 100. The keypad 140 also has a set of function keys for enabling various predetermined functions or operations. The term “keypad” as used herein includes alphanumeric keys, function keys and other buttons and touch sensitive sensors at various locations within the casing 110.

The display 150 provides information visually to the user. The telephone 100 may include several displays positioned at different parts of the telephone 100, such on an outside surface of the casing's upper portion 111. The displays may be liquid crystal displays or other flat panels, and/or may be projection type displays (e.g., a headset or a head's up display).

The telephone 100 has a clamshell design, but other configurations are compatible with the invention. The microphone 160 and the speaker 170 may be omitted from the casing 110 and instead be housed in the casing of a separate headset or speakerphone (not shown). The headset may be wired or wireless, and may be Bluetooth compatible.

When an incoming call is received by the telephone a call alert is activated to alert the user to the fact that there is an incoming call. The call alert may include an audible signal from the speaker 170 (e.g., one or more ring tones), and/or a visual signal such as a message displayed on the display 150, and/or a vibration. The call can be answered by the user by depressing one of the keys on the keypad 140, or by flipping the telephone 100 open, both of which produce an off hook condition in the telephone 100. When the telephone 100 is off hook, the user can hear the caller through the speaker 170 and can speak to the caller through the microphone 160. By “off hook” it is meant an operating state of the equipment of a communications link in which voice communications are enabled.

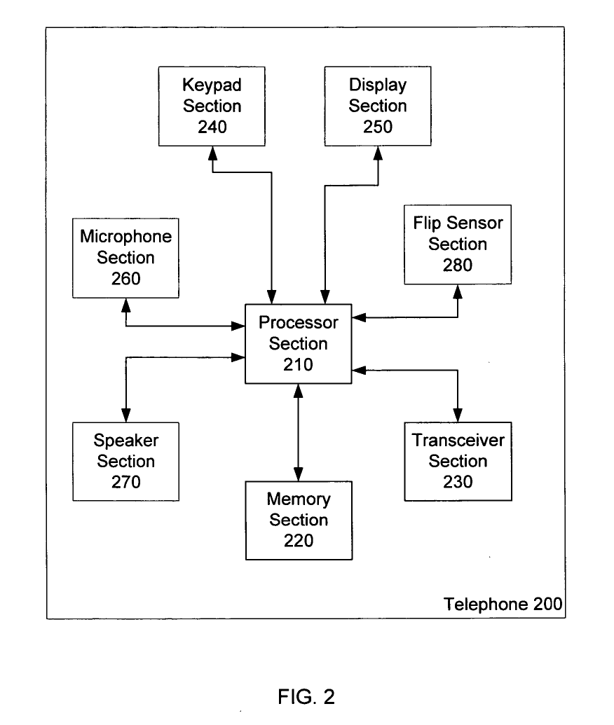

Referring now to FIG. 2 there is shown a block diagram of a telephone 200. The telephone 200 may be the telephone 100. The telephone 200 may be, for example, a wireless phone, a desk phone or a cordless phone. The telephone 200 can receive calls through at least one of a wireless or wire line telephone network, such as is typically practiced. The telephone 200 includes a processor section 210, a memory section 220, a transceiver section 230, a keypad section 240, a display section 250, a microphone section 260, a speaker section 270 and a flip sensor section 280.

The processor section 210 may be a single processor or a number of processors having separate functions. These processor section 210 may be or include one or more of: microprocessors, field programmable gate arrays (FPGAs), application specific integrated circuits (ASICs), programmable logic devices (PLDs), programmable logic arrays (PLAs), CODECs, analog-to-digital converters and digital-to-analog converters. The processor section 210 may include a spectral analyzer suitable, for example, for comparing a stored audio sample with a received audio sample. In this way, the spectral analyzer may be used for matching a voice print with a voice sample, as discussed below.

The memory section 220 may be or include one or more of RAM, ROM, rewritable flash, nanoscale ranom access memory (NRAM), magnetic memory, optical memory and/or others. The memory section 220 may be used to store programs and data for operation of the telephone 200.

The transceiver section 230 may be or include a network interface for interfacing with a digital, analog, wireless and/or wire line network. If the telephone 200 is a cordless phone, the transceiver section 230 may be for interfacing with a local base station.

The keypad section 240, the display section 250, the microphone section 260, the speaker section 270 and the flip sensor section 280 may include the corresponding components in FIG. 1. In addition, the keypad section 240, the display section 250, the microphone section 260, the speaker section 270 and the flip sensor section 280 may have respective circuits, connections, interfaces and parts as might be needed in the particular embodiment, and they may the same or comparable to those found in telephones on the market. For example, the speaker section 270 may include a speaker transducer and an amplifier. As another example, the display section 250 may include a display driver. The flip sensor section 280 may be omitted if the telephone 200 is not a flip phone.

The memory section 220, the transceiver section 230, the keypad section 240, the display section 250, the microphone section 260, the speaker section 270 and the flip sensor section 280 may be coupled to and regulated by the processor section 210 in the usual manner. Other arrangement and configurations are known in the art and may be used, as may other arrangements and configurations which may be employed in the future.

The telephone 200 has a speakerphone mode to permit hands free use of the telephone using the speaker section 270 and the microphone section 260. If the telephone 200 is a flip-type telephone (such as the telephone 100, FIG. 1), then the speakerphone mode may be used when the telephone is closed or open.

A telephone may include software and/or hardware for providing functionality and features described herein. The hardware and firmware components of the telephone 200 may include various specialized units, circuits, software and interfaces for providing the functionality and features described here. The invention may be embodied in whole or in part in software which operates on a telephone and may be in the form of firmware, an application program, an applet, a script, one or more subroutines, or an operating system component or service. The hardware and software of the invention and its functions may be distributed such that some components are performed by a client computer and others by other devices.

Description of Methods

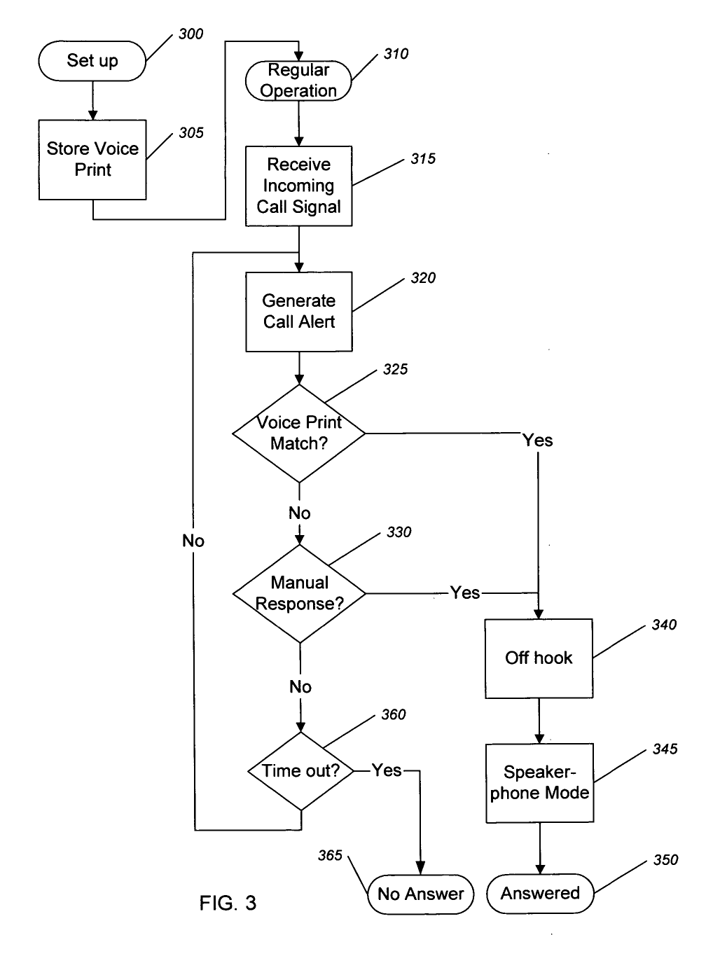

Referring now to FIG. 3 there is shown a flowchart of methods of answering phone calls. The methods may be practiced in the telephone 200, for example using the processing section 210, the memory section 220 and other sections, circuits and software.

In a set up part of the method (step 300), a voice print of a user is stored in the telephone (step 300). The voice print may be loaded into the telephone. The voice print may be stored in the telephone's memory as a compressed or uncompressed digitized speech pattern.

The user may initiate storing the voice print using the telephone's keypad and putting the telephone in an appropriate programming mode. The telephone may prompt the user, for example with a beep tone, at the start and end of recording. The telephone may use its microphone to record the voice print. The voice print may be processed by the telephone's processor section. The processing section may set a status flag in memory to indicate that the voice print was recorded. In addition, the processing section may cause a corresponding indicator to be displayed on the telephone's display.

Although it has been presumed that the voice print would take the form of a user's voice, other sounds may be used as the voice print. For example, the user may wish to clap their hands, click their tongue or generate some other bodily or non-bodily generated sound. On the other hand, it may be desirable to require the user's voice as the voice print, and to therefore reject recordings which fail to have the properties of a human voice, or of the user's voice.

After the telephone has been set up, it can be used in regular operation (step 310). Regular operation of any telephone includes receiving and recognizing a signal of an incoming call (step 315). Depending on the telephone and the network to which it connects, the signal may take various forms.

Next, the telephone generates a call alert for the user (step 320). Of course, the user may or may not be present to receive the call alert.

Next, the telephone begins monitoring for a voice signal which matches the voice print (step 325). This may be performed, for example, by sampling audio through the microphone and making the comparisons using the telephone's processing section. In the monitoring step (step 325), the telephone's microphone may be enabled. In embodiments where the call alert is audible (as opposed to only visual), the microphone may be enabled only when the call alert is not being made, such as between rings. It may be desirable to perform the monitoring step (step 325) only if the status flag was set to indicate that a voice print was recorded. It may be desirable to reject a sample if the sample falls below a preprogrammed threshold level, and the rejection may be performed either before or after comparing the sample with the voice print.

Upon determination of a match, the telephone goes directly off hook (step 340) and enables use of the microphone and the speaker without further steps by the user or the telephone (step 345). In conjunction with going off hook, the telephone also discontinues generating the call alert.

In addition to monitoring for a match of a voice signal with the voice print, the telephone may monitor for a manual response (step 330). The manual response may be in the form of manipulation of the telephone in a predetermined manner. If the telephone recognizes that it has been manipulated in the predetermined manner, the telephone may go off hook and enable use of the microphone and the speaker. The predetermined manner occur, for example, when the user flips open the casing of the telephone, or presses of one or more predetermined buttons on the telephone.

If the telephone includes a speakerphone mode, then the step of directly going off hook may be or include activating the speakerphone mode.

If the user is not present, cannot receive the call, or chooses not to take the call, the call alert may continue for a predetermined timeout period. If the timeout is reached (step 360), then either the telephone or the network to which the telephone connects will recognize a “no answer” condition (step 365). As a result, monitoring for a voice print match (step 325) or a manual response (step 330) may be performed for a predetermined timeout.

Performance of voice print matching may be enhanced in a number of ways. According to one enhancement, the length of the voice print is limited to be less than the timeout. This may occur in conjunction with storing the voice print (step 305) or at a later time. This may also be achieved by providing a memory of a length sufficient only to store a voice print of a duration less than the predetermined timeout. According to another enhancement, the comparison is made of a portion of the voice print, and that portion is limited to be shorter than the timeout. In restricting the length of the voice print, the limit may be fixed to about one third of the timeout. More so, the voice print should be restricted to less than 1 second, and could be restricted to less than ½ second for good effect.

During the storing step 205, if the user attempts to store a voice print which is longer than permitted or recommended period, the telephone may provide feedback to indicate that the voice print should be shorter and/or that the user should record a new voice print.

With regard to FIG. 3, additional and fewer steps may be taken, and the steps as shown may be combined or further refined to achieve the methods described herein.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

It is claimed:

1. A method of answering a phone call, the method comprising
providing a telephone having a casing, a microphone, a speaker and a memory, wherein the telephone is for receiving calls through at least one of a wireless or wire line telephone network
storing a voice print of a user in the memory
receiving by the telephone a signal of an incoming call
generating a call alert
monitoring for a voice signal which matches the voice print, and upon determination of a match, directly going off hook and enabling use of the microphone and the speaker without further steps by the user or the telephone
wherein the step of generating a call alert is terminated in conjunction with going off hook.

2. The method of answering a phone call of claim 1 wherein the storing step comprises limiting the voice print to a length of less than one second.

3. The method of answering a phone call of claim 1, wherein the telephone includes a speakerphone mode to permit hands free use of the telephone through the speaker and the microphone, and the step of directly going off hook comprises activating speakerphone mode.

4. The method of answering a phone call of claim 1, wherein the memory, the microphone and the speaker are disposed within the casing.

5. The method of answering a phone call of claim 1, further comprising monitoring for a manual response comprising manipulation of the telephone in a predetermined manner, and upon detection of the manual response, going off hook and enabling use of the microphone and the speaker.

6. The method of answering a phone call of claim 5 wherein the predetermined manner is selected from the group comprising flipping open the casing of the telephone and pressing a button of the telephone.

7. The method of answering a phone call of claim 1 wherein the monitoring step is performed for a predetermined timeout.

8. The method of answering a phone call of claim 1 wherein the telephone is selected from the group comprising a cordless phone, a wireless phone and a desk phone.

9. A telephone comprising
a casing
a microphone
a speaker
a memory disposed within the casing
a speakerphone mode to permit hands free use of the telephone through the speaker and the microphone
means for storing a voice print of a user in the memory
means for receiving by the telephone a signal of an incoming call
means for generating a call alert to the user and for terminating the call alert in conjunction with going off hook
means for monitoring for a voice signal which matches the voice print, and upon determination of a match, directly going off hook and enabling use of the microphone and the speaker without further steps by the user or the telephone.

10. The telephone of claim 9 further comprising means for limiting the voice print to a length of less than one second.

11. The telephone of claim 9, wherein the telephone includes a speakerphone mode to permit hands free use of the telephone through the speaker and the microphone, and directly going off hook comprises activating speakerphone mode.

12. The telephone of claim 9, wherein the memory, the microphone and the speaker are disposed within the casing.

13. The telephone of claim 9, further comprising means for monitoring for a manual response comprising manipulation of the telephone in a predetermined manner, and upon detection of the manual response, going off hook and enabling use of the microphone and the speaker.

14. The telephone of claim 13 wherein the predetermined manner is selected from the group comprising flipping open the casing of the telephone and pressing a button of the telephone.

15. The telephone of claim 9 wherein monitoring is performed for a predetermined timeout.

16. The telephone of claim 9 wherein the telephone is selected from the group comprising a cordless phone, a wireless phone and a desk phone.

17. A telephone
a microphone
a speaker for providing a speakerphone mode to permit hands free use of the telephone through the speaker and the microphone
a processor section
a memory section
wherein the processor section and the memory section comprise circuits and software for
storing a voice print of a user in the memory
receiving by the telephone a signal of an incoming call
generating a call alert to the user and for terminating the call alert in conjunction with going off hook
monitoring for a voice signal which matches the voice print, and upon determination of a match, directly going off hook and enabling use of the microphone and the speaker without further steps by the user or the telephone.

18. The telephone of claim 17 further comprising means for limiting the voice print to a length of less than one second.

19. The telephone of claim 17, wherein the telephone includes a speakerphone mode to permit hands free use of the telephone through the speaker and the microphone, and directly going off hook comprises activating speakerphone mode.

20. The telephone of claim 17, wherein the memory, the microphone and the speaker are disposed within the casing.

21. The telephone of claim 17, further comprising means for monitoring for a manual response comprising manipulation of the telephone in a predetermined manner, and upon detection of the manual response, going off hook and enabling use of the microphone and the speaker.

22. The telephone of claim 13 wherein the predetermined manner is selected from the group comprising flipping open the casing of the telephone and pressing a button of the telephone.

23. The telephone of claim 17 wherein monitoring is performed for a predetermined timeout.

24. The telephone of claim 17 wherein the telephone is selected from the group comprising a cordless phone, a wireless phone and a desk phone.
